(19) United States
(12) Patent Application Publication
(10) Pub. No.: US 2003/0020841 A1
(43) Pub. Date: Jan. 30, 2003

(54) Integral apparatus of television and video deck and door supporting structure

(76) Inventor: Kenichi Takeda, Osaka (JP)

Correspondence Address: Jonathan P. Osha, ROSENTHAL & OSHA L.L.P., 700 Louisiana, Suite 4550, Houston, TX, 77002, US

(21) Appl. No.: 10/202,333

(22) Filed: Jul. 24, 2002

(30) Foreign Application Priority Data
Jul. 30, 2001 (JP) U2001-004977

(51) Int. Cl. H04N 5/64

(52) U.S. Cl. 348/839

(57) ABSTRACT

A door supporting structure includes a cabinet having an opening portion, a door, and first and second supporting shafts provided on the door, the second supporting shaft having a contact face on a protruding end. The door supporting structure further includes bearings disposed on the cabinet, each of the bearings having a shaft inserting portion in which the first and second supporting shaft is inserted respectively, and an elastic member disposed on the first supporting shaft, the elastic member exerting an urging force and a rotation force on the door, and a positioning portion disposed in the vicinity of the contact face. The elastic member is interposed between the door and one of the bearings to urge the door along the shaft center so that the contact face passed through the other bearing is in contact with the positioning portion disposed in the vicinity of the other bearing.

### BACKGROUND OF THE INVENTION

1. Field of the Invention

The present invention relates to an integral apparatus of television and video deck and a door supporting structure, and more particularly to an integral apparatus of television and video deck and a door supporting structure in which the occurrence of vibration noise can be easily prevented.

2. Description of the Related Art

The conventional door supporting structure is known by a technology as disclosed in publication of Japanese utility model application No.53-127921. FIG. 11 is an explanatory view showing the door supporting structure as disclosed in that publication. In FIG. 11, a door 1 has a notch 2 for engaging a spring 4 to the left side in the figure. Upper part of the door 1 is curved to provide an insertion hole 3. A shaft 5 for supporting the door 1 is inserted into the insertion hole 3, and a collar 6 is so formed at one end side of the shaft 5 as to protrude the shaft's top end.

In this constitution, the door 1 is supported via the shaft 5 by a frame body 7. That is, the frame body 7 is provided with the shaft holes 7a, whereby the shaft 5 is supported in the shaft holes 7a in a state where the spring 4 is inserted through the shaft 5 and the shaft 5 is inserted into the insertion hole 3, as shown in FIG. 11. In this state, the spring 4 applies an urging force to the collar 6 and the door 1 to press the collar 6 in a direction toward the frame body 7, while an end face of the door 1 is pressed against the frame body 7 on the opposite side. At one end side of the spring 4, the top end is directed in an outer radial direction of the shaft 5, this top end is in contact with the frame body, not shown. The spring 4 exerts a force for rotating the door 1 around the shaft 5, whereby the door 1 is placed at a position of FIG. 11 in the normal state. If the user presses the door 1, as needed, the door 1 is rotated rearwards.

In the above conventional door supporting structure, the collar 6 and the end face of the door 1 contacted with the frame body 7 are planar, and the frame body 7 is also planar. Accordingly, they are in facial contact. This door supporting structure is employed to an insertion hole for a cassette tape, etc. Such insertion hole is employed to an acoustic appliance from which sound is produced. This sound generates vibration on the contact faces that are in facial contact, and develops the vibration noise. To prevent this kind of vibration noise, conventionally, the contact face was coated with grease. However, with this constitution, the grease takes some cost, and a grease coating process is needed. Furthermore, the grease may be leaked out during the use.

### SUMMARY OF THE INVENTION

The present invention has been achieved in the light of the above problems, and it is an object of the invention to provide an integral apparatus of television and video deck and a door supporting structure in which the occurrence of vibration noise can be prevented without using a lubricant and with a simple constitution.

In order to accomplish the above object, there is provided an integral apparatus of television and video deck, including a cabinet having an opening portion on a front face of the cabinet to allow insertion of a video cassette into the cabinet; a door having a rotation plane for covering the opening portion; a supporting shaft provided on the door for rotating the rotation plane, the supporting shaft having a contact face on one end thereof; a helical spring in which another end of the supporting shaft is inserted; first and second bearings disposed on an inner surface of the cabinet, each of bearings, in which the supporting shaft is inserted, having a wider clearance than an outer diameter of the supporting shaft; and a boss disposed in the vicinity of the second bearing, wherein the helical spring is interposed between a side end portion of the door and the first bearing, each of end portions of the spring is stretched in a tangential direction of the helical circle of the spring, one end portion of the spring is in contact with the cabinet and the other end portion of the spring is in contact with the door to exert a rotation restoring force of the spring on the door to urge the rotation plane toward the opening portion so that the opening portion is closed with the door at a normal state, the boss is formed substantially cylindrically, the boss protrudes from the inner surface of the cabinet almost orthogonally to a direction along which the supporting shaft is disposed, the contact face is formed substantially planar, the door is urged toward the contact face of the supporting shaft by the spring of which one end is in contact with the first bearing, and the contact face is in contact with an outer circumferential curved face of the boss.

With the above constitution, the integral apparatus of television and video deck has the cabinet front face with the opening portion to allow insertion of a video cassette, and the opening portion is closed with the door at the normal state. Herein, in inserting the video cassette, the door is rotated to enable the opening portion to be opened. The following constitution is employed to prevent the vibration noise occurring from the door due to vibration caused by the reproduced sound of the television.

The door has the rotation plane and the supporting shaft for rotating the rotation plane. The rotation plane is shaped to cover the opening portion, and the supporting shaft can rotate the rotation plane around it. Furthermore, the helical spring can be inserted at one end of the supporting shaft. The integral apparatus of television and video deck has the bearings formed inside the cabinet, and the spring can be interposed between the door and the bearing by inserting it through the supporting shaft. Also, the end portions of the spring are stretched in the almost tangential direction of the helical circle, one of the end portions of the spring stretched being contacted with the cabinet, and the other end portion contacted with the door. Thereby, a rotation restoring force of the spring is exerted on the supporting shaft to urge the rotation plane of the door toward the opening portion at the normal state. As a result, the opening portion is closed with the door at the normal state. Since the spring is in contact with the bearing, the supporting shaft is urged in the direction toward its other end. In this constitution, the contact face of the supporting shaft at the other end is almost planar, and the almost cylindrical boss is formed near the bearing at the other end side to protrude into the inside of the cabinet almost orthogonally to the direction along which the supporting shaft is disposed. Accordingly, the contact face of the supporting shaft at the other end to be urged is contacted with the outer circumferential curved face of the boss.

That is, because the supporting shaft is urged in the axial direction, and contacted with the boss, the door is not deviated in the direction of supporting shaft owing to the contact of the boss, and positioned in the direction of supporting shaft. Furthermore, the bearings have a wider clearance than the outer diameter of the supporting shaft to support the supporting shaft in a free state, but because the boss and the bearing are located closely, the outer circumferential face of the boss that is the reaction point of the urging force and the beating are located closely, whereby no vibration occurs against the urging force even though the sound is produced. Also, the contact face of the supporting shaft is planar, and the outer circumferential face of the boss is curved, whereby they are contacted at one point and the vibration noise caused by the sound is unlikely to occur.

In order to accomplish the above object, there is provided a door supporting structure, including a cabinet having an opening portion; a door for covering the opening portion; first and second supporting shafts provided on the door and protruding in opposite directions to each other, the supporting shafts having a common shaft center around which the door is rotated, the second supporting shaft having a contact face on a protruding end; a pair of bearings disposed on an inner surface of the cabinet, each of the bearings having a shaft inserting portion in which the first and second supporting shaft is inserted respectively; an elastic member disposed on the first supporting shaft, the elastic member exerting a rotation force on the door; and a positioning portion disposed in the vicinity of the contact face, wherein the elastic member is interposed between the door and one of the bearings to urge the door along the shaft center so that the contact face passed through the other bearing is in contact with the positioning portion disposed in the vicinity of the other bearing.

With the above constitution, to support the door to be openable or closable from or to the opening portion of the cabinet, the door is provided with the first and second supporting shafts and the cabinet is formed with the bearings and the positioning portion. The supporting shafts are disposed so that the ends of the supporting shafts protrude in opposite directions to each other on the opening or closing support axial line. The door is held rotatably and undetachably on the bearings by inserting the supporting shafts through a pair of bearings on the opening or closing support axial line from the side of an opposed face of the bearings formed with the shaft inserting portion for inserting the supporting shaft, the bearings being formed in the cabinet. The elastic member is passed through one end of the supporting shafts and interposed between the door and the bearing to urge the door along the opening or closing support axial line in a fixed direction to be rotated in a predetermined direction around the support axial line. Also, the positioning portion is disposed to be contactable with the supporting shaft at the other end side of the supporting shaft having the elastic member, the positioning portion is disposed on the reverse side of the opposed face of the bearings.

That is, one bearing is directly subjected to an urging force from the elastic member, and always placed under the tension, whereby the vibration noise is unlikely to occur. On the other bearing side, an urging force of the supporting shafts is exerted on the positioning portion disposed outside on the opening or closing support axial line, so that the positioning portion is always placed under the tension, whereby the vibration noise is unlikely to occur. Herein, the effect of preventing the occurrence of vibration noise is greater as the distance between the bearing and the positioning portion is smaller. Furthermore, the effect of preventing the occurrence of vibration noise is greater as the contact area between the supporting shaft and the positioning portion is smaller.

Also, there is provided a door supporting structure, including a cabinet having an opening portion to allow insertion of an inserting object; a door having a rotation plane for covering the opening portion; first and second supporting shafts provided on the door for rotating the rotation plane, the second supporting shaft having a contact face on protruding end thereof; at least two bearings disposed on the cabinet, each of the bearings having a shaft inserting portion in which each of the first end second supporting shafts is inserted; an elastic member disposed on the first supporting shaft, the elastic member exerting an urging force on the door in a direction of the supporting shaft, the elastic member exerting a rotation restoring force on the door in a direction around the urging force; and a positioning portion disposed in the vicinity of one of the bearings, wherein the contact face of the second supporting shaft is in contact with the positioning portion by the urging force of the elastic member to determine an axial position of the door, the positioning portion is contactable with the contact face substantially in point contact.

With the above constitution, the cabinet is formed with the opening portion to allow insertion of a predetermined inserting member into the cabinet, and closed with the door in the normal state. Herein, the door is rotated to open the opening portion, when inserting the predetermined member. The following constitution is employed to prevent the vibration. noise occurring from the door due to vibration caused within or outside the cabinet. That is, the cabinet is formed with the bearings at at least two positions, and the door having the rotation plane covering the opening portion is provided with the supporting shafts having a smaller outer diameter than a clearance of the shaft inserting portion for the bearing, and has the elastic member engaged at one end. The positioning portion is provided near one of the bearings in the cabinet to be contacted with an contact face of the second supporting shaft substantially in point contact to determine the axial position of the door.

The elastic member exerts an urging force in one direction, and exerts a rotation force in the rotational direction around the action line on the rotation plane substantially perpendicular to the direction of the action line of the urging force. Accordingly, if the elastic member is engaged with the supporting shaft, and inserted into the bearing, and an urging force is applied between the bearing and the engagement portion of the supporting shaft, the supporting shaft is urged in the axial direction. As a result, the contact face of the supporting shaft is contacted with the positioning portion. Also, if a rotation restoring force of the elastic member is exerted in the rotational direction of the supporting shaft, a rotational force can be applied on the door in one rotational direction, whereby the rotation plane of the door can be urged in the direction toward the opening portion in the cabinet at the normal state. Of course, if the door is pressed, the door can be rotated against this rotation restoring force and opened.

That is, the supporting shaft is urged in the direction toward the positioning portion by the elastic member, whereby the supporting shaft and the positioning portion are contacted substantially in point contact. Accordingly, the movement of the supporting shaft in the axial direction owing to an urging force is stopped by the positioning portion, thereby locating the supporting shaft in the axial direction. Since the supporting shaft and the positioning portion are contacted substantially in point contact, an urging force is concentrated substantially at one point, unlikely producing a force for drawing the contact portions apart against the urging force due to various vibrations such as the voice from the inside or outside, whereby it is possible to prevent the occurrence of vibration noise at the contact point. Also, since the supporting shaft is positioned by the positioning portion, there is no need that the bearings to be closely contact with the outer circumference of the supporting shaft. Therefore, the supporting shaft can be supported with a room.

The supporting shaft is not moved and the vibration noise is not produced, unless a force is applied to withstand the urging force at the contact point between the positioning portion and the supporting shaft. However, there is an increased movable margin due to warpage of the door or the supporting shaft as being farther away from the contact point. Accordingly, if the bearings and the positioning portion are left farther away, the vibration noise can occur at the contact point between the bearings and the supporting shaft, while in this invention, because the bearings and the positioning portion are proximate, the bearings are proximate to the action point of the urging force on the positioning portion, whereby there is less movable margin for the supporting shaft, unlikely producing the vibration noise.

In the description of this specification, the predetermined member is employed to be in or out of the cabinet, and not specifically limited. For example, this predetermined member may be a video cassette, a video tape, a CD-ROM, or a DVD. Rather, this invention can be broadly applied to various members such as a battery and a connector that can be inserted into the cabinet, besides the above recording media. The bearings may be provided at at least two positions, which are not limited by other factors than the positional relation with the positioning portion, but the bearings are preferably disposed near both ends of the supporting shaft, because they can stably support the supporting shaft.

The elastic member may be necessary to exert an urging force in one direction, and exert a rotation restoring force in the rotational direction around the action line on the rotation plane substantially perpendicular to the direction of the action line of the urging force, and maybe any one of various members. For example, the use of a helical spring allows an urging force to be exerted in the direction of helical axis, and allows an end portion of the spring to be contacted with the rotation plane of the door by stretching the spring in the spring outer circumferential direction and contacted, thereby exerting a rotation restoring force in the rotational direction around the helical axis. Besides, the elastic member may be formed of various members such as a rubber member molded like a cylinder or column.

The supporting shaft may have a smaller outer diameter than the clearance of the shaft inserting portion in the bearing, or the portion for inserting the supporting shaft. With this constitution, the supporting shaft can be supported with a margin without intimate contact of the bearing with the outer circumference of the supporting shaft, whereby the warpage in the door, the supporting shaft or the cabinet has no interference on the rotation operation of the door. The elastic member may be engaged in various ways. For example, a spring or cylindrical rubber may be engaged by making the outer diameter of the end portion of the supporting shaft slender, or engaged at the edge of the door by connecting the supporting shaft to the upper end of the door. The rotation plane may cover the opening portion of the cabinet, and preferably cover the entire opening portion in the design, although it is unnecessary to cover the entire opening portion. Moreover, a slit may be provided on the rotation plane.

The positioning portion may be provided near one of the bearings. That is, it is required to prevent the occurrence of vibration noise by disposing both the positioning portion and one of the bearings proximately. The conditions may be varied depending on the materials of the door, the supporting shaft, and the positioning portion, or the intensity of vibration occurring inside or outside, but the distance between the positioning portion and the bearing may be appropriately changed to the extent that the occurrence of vibration noise is prevented. Also, the positioning portion and the contact face of the supporting shaft may be contacted substantially in point contact. That is, it is required that the occurrence of vibration noise is effectively prevented by concentrating an urging force substantially on one point because of substantial point contact. Therefore, there is no need that the positioning portion and the end face of the supporting shaft are contacted strictly at one point.

As one preferable example of the positioning portion, one of the contact face and a contact region of the positioning portion is almost planar, and the other is almost curved. That is, if the curved member is disposed proximately to the planar member, both are contacted substantially at one point. Accordingly, one of the contact face and the contact region of the positioning portion is made almost planar, and the other almost curved, whereby the supporting shaft and the positioning portion can be easily contacted substantially at one point.

Further, the positioning portion is a substantially cylindrical boss that is protruded almost orthogonally to a direction along which the supporting shaft is disposed. That is, since the almost cylindrical member can be very easily formed, and the outer circumference of the cylindrical member is curved, the boss and the supporting shaft can be easily placed in point contact by protruding the boss substantially at right angles to the direction where the supporting shaft is disposed, and making the end face of the supporting shaft almost planar. Though various cabinets molded of resin are employed in various electronic appliances, the almost cylindrical boss can be very easily molded of resin, which is particularly preferable.

Moreover, the positioning portion is a member connected with one of the bearings to define a U-shaped cross section with the bearing, the contact face of the supporting shaft is curved That is, the positioning portion and the bearing can be formed integrally, and the portion of almost U-character shape in cross section has three inner faces that are almost planar, opposed two faces serve as the bearings and the remaining one face serves as the positioning portion. Herein, though the positioning portion is planar and the end face of the supporting shaft is curved, the positioning portion and the supporting shaft are contacted substantially at one point. Rather, the positioning portion may be curved and the end face of the supporting shaft may be made planar.

As described above, the present invention can provide an integral apparatus of television and video deck for preventing the occurrence of vibration noise caused by the sound.

Also, the present invention provides a door supporting structure in which the vibration noise is unlikely to occur.

Moreover, according to one aspect of the present invention, the contact face of the supporting shaft and the contact region of the positioning portion can be contacted substantially at one point.

Further, according to other aspect of the present invention, the contact face of the supporting shaft and the positioning portion can be easily placed in point contact.

Further, according to other aspect of the present invention, the positioning portion and the bearing can be formed integrally.

### BRIEF DESCRIPTION OF THE DRAWINGS

FIG. 1 is a perspective view showing an integral apparatus of television and video deck employing a door supporting structure according to a first embodiment of the present invention;

FIG. 2 is an exploded perspective view showing a front cabinet, partly cut away, as seen from the back face;

FIG. 3 is a rear view showing a state in which a door is supported around a supporting shaft;

FIG. 4 is a side view of the door;

FIG. 5 is an explanatory view for explaining how the supporting shaft swings;

FIG. 6 is an explanatory view for explaining how the supporting shaft swings;

FIG. 7 is an exploded perspective view showing a front cabinet, partly cut away, as seen from the back face;

FIG. 8 is a cross sectional view, taken along the line A-A in FIG. 7, showing a second embodiment of the invention;

FIG. 9 is an exploded view of a bearing portion according to another embodiment of the invention;

FIG. 10 is an exploded view of a bearing portion according to another embodiment of the invention; and

FIG. 11 is an explanatory view showing a door supporting structure in the conventional example.

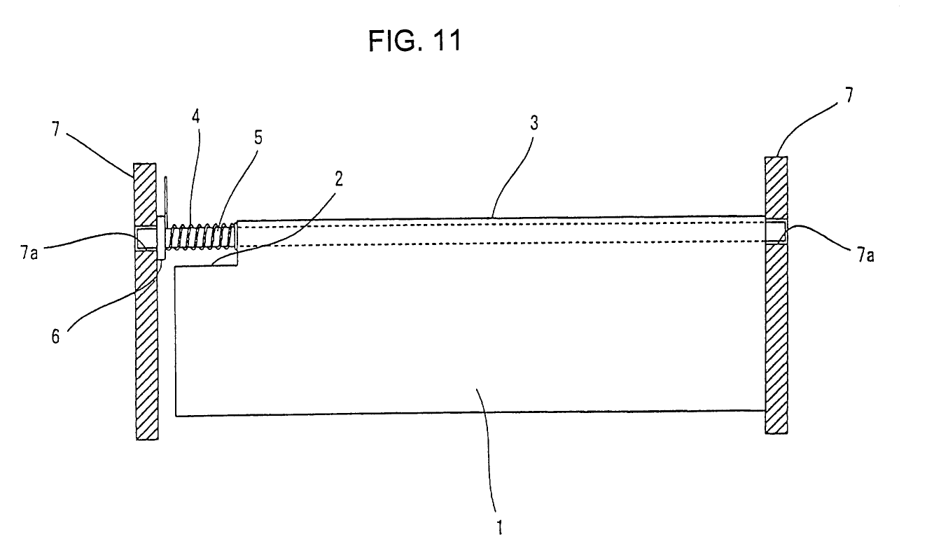

### DETAILED DESCRIPTION OF THE PRESENT INVENTION

The preferred embodiments of the present invention will be described below in the following order.

(1) Integral apparatus of television and video deck

(2) Door supporting structure

(3) Prevention of vibration noise

(4) Second embodiment

(5) Other embodiment

(1) Integral Apparatus of Television and Video Deck

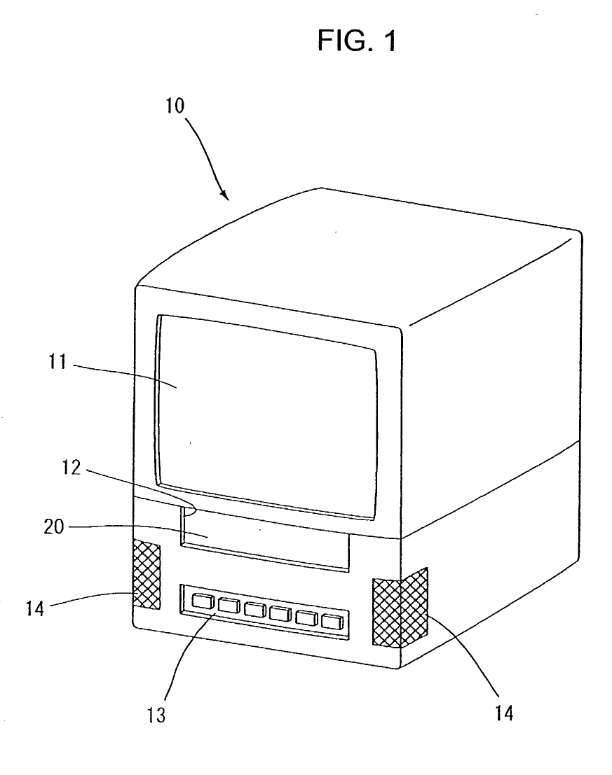

FIG. 1 is a perspective view showing an integral apparatus of television and video deck employing a door supporting structure according to one embodiment of the present invention. The integral apparatus of television and video deck 10 includes a roughly rectangular housing, most of its outer face being covered with a cabinet made of resin molding. A television picture tube 11 is disposed on an upper portion of the integral apparatus of television and video deck 10, its fluorescent screen being exposed from an opening portion of the cabinet. A video unit, not shown, mounting various circuits for implementing the functions of a video apparatus is contained beneath the television picture tube 11 inside, and an opening portion 12 for inserting a video cassette is provided on the front face of the cabinet.

Rearward of this opening portion 12, a door 20 is supported in a structure as will be described later. Under the opening portion 12, a substrate mounting various circuits for implementing the functions of the television apparatus is contained, whereby the user can make various operations on the operation panel 13 at the lower part of the cabinet front face to employ the television function and the video deck function to display the picture. Also, the speaker opening portions 14a are disposed on both sides at the lower part of the cabinet front face to output the sound as the picture is displayed. This sound output is a source of vibration, and the door 20 is supported such that the vibration noise is not produced by this vibration of sound.

(2) Door Supporting Structure

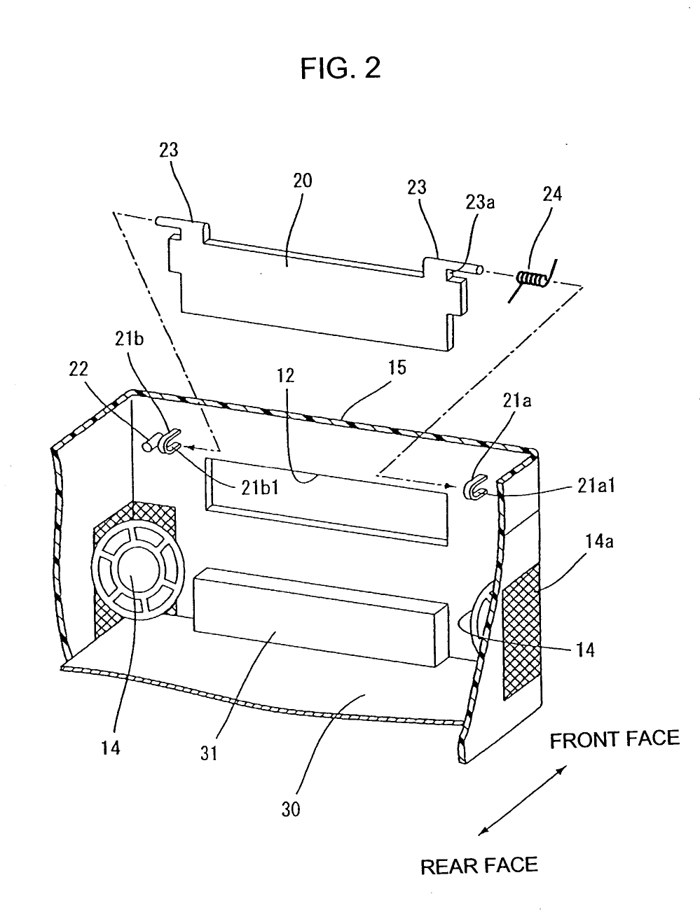

FIG. 2 is an exploded perspective view showing a front cabinet 15 of the integral apparatus of television and video deck 10, partly cut away, as seen from the back face. In FIG. 2, a region for supporting the door 20 is shown. The opening portion 12 is rectangular, and is provided almost centrally in the front cabinet 15. A substrate 30 is disposed under the opening portion 12. The substrate 30 mounts various circuits and a switch box 31 disposed on the back face of the operation panel 13 and acceptingvarious button operations on the operation panel 13. A speaker 14 is disposed on the back face of a speaker opening portion 14a and outputs various sounds for an audio signal input via the wirings, not shown, on the substrate 30,

The bearings 21a and 21b are disposed above and outside the short sides of the opening portion 12. The bearings 21a and 21b are integrally molded to protrude substantially vertically on the back face of the front cabinet 15, and provided with the holes 21a1 and 21b1 that are of almost same shape and serve as the insertion portions of the supporting shaft. A boss 22 is disposed near one bearing 21b. The boss 22 is a cylindrical portion integrally molded with the back face of the front cabinet 15 to protrude substantially vertically to the back face, and disposed to locate on the extension of the hole 21b1 for the bearing 21.

The door 20 is a resin member like a roughly rectangular plate, with the supporting shaft 23 integrally molded to extend from both the ends of one long side and be oriented outward in parallel to the long side. A rectangular protruding portion 25 is integrally molded on the short side. The supporting shaft 23 has an end face molded like a plane, and is formed at each of two locations at the edges of the long side. The shaft centers of both the supporting shafts 23 are common, and the supporting shafts 23 are supported by two bearings 21a and 21b to allow the door 20 to be rotated around the rotation axis. Also, the outer diameter of both the supporting shafts 23 are smaller than the inner circumference of the holes 21a1 and 21ba in the bearings 21a and 21b, whereby the bearings 21a and 21b support the supporting shafts 23 in a free state.

A spring 24 can be inserted through one end of the supporting shaft 23 up to the edge of the short side of the door 20. Accordingly, the edge of the door 20 serves as an engagement portion 23a of the spring 24. That is, the spring 24 is a helical spring, in which its inner circumferential diameter is substantially the same as the outer circumferential diameter of the supporting shaft 23. The spring 24 is inserted through the supporting shaft 23 up to the contact with the engagement portion and engaged. The door 20 is supported by the bearings 21a and 21b in a state where the spring 24 is engaged with the engagement portion 23a. To this end, the spring 24 is closely contacted with the supporting shaft 23, and the end portion of the supporting shaft 23 engaged with the spring 24 is inserted into the hole 21a1 of the bearing 21a.

The spring 24 can apply a flexible force in the axial direction of the supporting shaft 23 in a state where it is engaged with the supporting shaft 23, and due to its reaction, exert a biasing force in the axial direction of the supporting shaft 23. As described above, the end portion of the supporting shaft 23 on the side of the spring 24 is inserted into the hole 21a1 of the bearing 21a, and further pushed in an insertion direction, so that the spring 24 is flexed in the axial direction to enable the other end of the supporting shaft 23 to be located inside the bearing 21b (on the side of the bearing 21a). Accordingly, if the other end of the supporting shaft 23 is inserted into the hole 21b1 of the bearing 21b while releasing a flexure of the spring 24 from this state, the supporting shafts 23 can be supported by the bearings 21a and 21b.

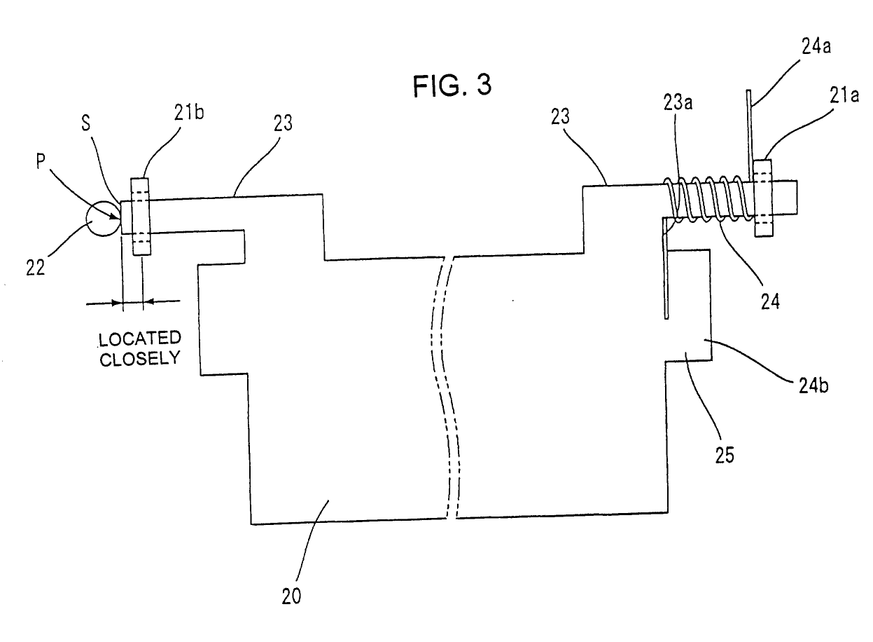

In this manner, the spring 24 is not sufficiently stretched in a state where the supporting shafts 23 are supporting shaft 21a and 21b, and can still exert a biasing force in a direction toward the other end of the supporting shaft 23. Accordingly, the other end of the supporting shaft 23 makes contact with the outer circumference of the boss 22 while being urged. FIG. 3 is a rear view showing a state where the door 20 is supported by the bearings 21a and 21b. As described above, an end face S at the other end of the supporting shaft 23 is almost planar, and the boss 22 is cylindrical, whereby the end face S and the boss 22 are contacted substantially in point contact.

On the other hand, the spring 24 exerts a biasing force in the axial direction of the supporting shaft 23, and urges the door 20 in a direction toward the opening portion 12 in the normal state, whereby the user can rotate the door 20 at discretion by pressing the door 20 inwards from the front face of the front cabinet 15. That is, the end portions 24a and 24b of the spring 24 are extended in an outer radial direction from a cylindrical base substance, in which an end portion 24a is contacted with the back face of the front cabinet 15, and an end portion 24b is contacted with the back face of the protruding portion 25 in the door 25. In this manner, if a rotation force around the axis of the spring 24 is exerted to the end portions 24a and 24b extended in the outer radial direction from the spring 24, a rotation restoring force for restoring the spring 24 to the stationary state is applied.

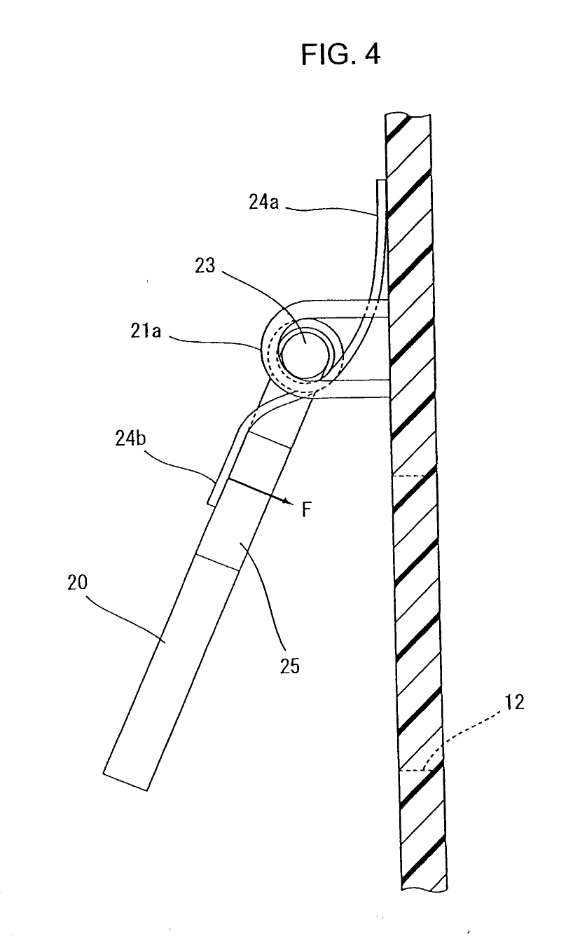

FIG. 4 is a side view of the door 20. As shown in FIG. 4, if the door 20 is pressed and rotated, the end portion 24b exerts a rotation restoring force F to the back face of the protruding portion 25. Accordingly, if a pressing force is released, the door 20 is rotated around the axis of the supporting shaft 23 due to the rotation restoring force F, so that the door 20 covers the opening portion 12 in the normal state where the door 20 is not pressed.

(3) Preventing the Vibration Noise

In the above constitution, a way of how to prevent the occurrence of vibration noise will be discussed below. In this embodiment, since the outer diameter of the supporting shaft 23 is smaller than the inner circumference of the bearing 21b, the bearing 21b and the boss 22 are formed very closely, and the supporting shaft 23 and the boss 22 are contacted at point P, thereby preventing the occurrence of vibration noise, as shown in FIG. 3. If the supporting shaft 23 and the boss 22 are contacted at point P, the biasing force of the spring 24 on the supporting shaft 23 is concentrated on point P.

Considering two faces that are contacted by a predetermined biasing force, a greater pressure is applied for making both faces contact as the contact area is narrower. Consequently, a vertical drag that is a main component of the frictional force is increased and a damping frictional force is increased. Accordingly, it is difficult to slidingly moving the supporting shaft 23 and the boss 22, unlike the facial contact, the vibration noise is unlikely to occur between the supporting shaft 23 and the boss 22 due to vibration caused by the sound from the speaker 14.

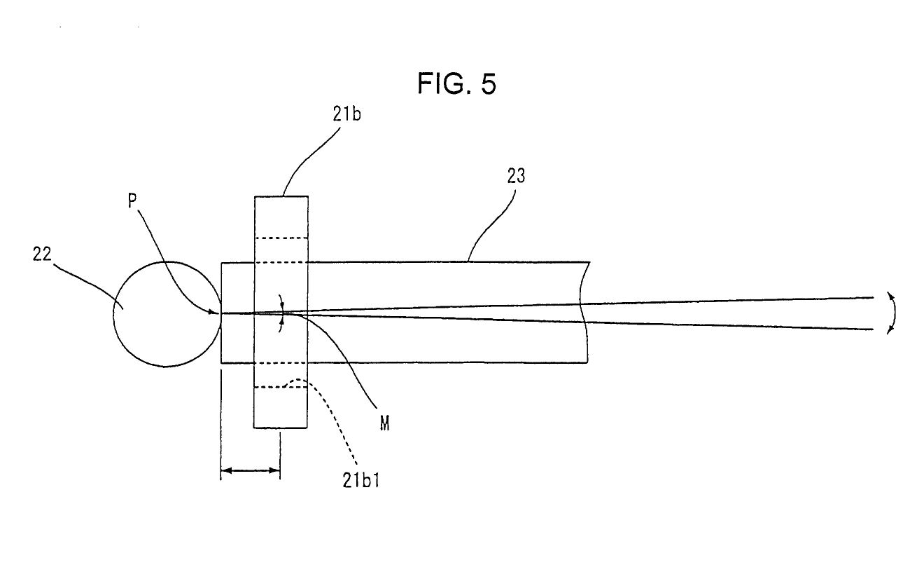

If a force for fluctuating the door 20 is exerted due to the vibration caused by the sound from the speakers, the supporting shaft 23 is forced to oscillate at a fulcrum of point P in a state where the supporting shaft 23 and the boss 22 are not relatively moved at point P, as shown in an enlarged view of FIG. 5. As shown in FIG. 5, the amount of oscillation is greater as farther away from the point P. In this invention, because the distance between the point P and the bearing 21b is very proximate, the amount of oscillation M near the bearing 21b is very small with almost no oscillation. Accordingly, the vibration noise is unlikely to occur between the outer circumferential face of the supporting shaft 23 and the inner circumferential face of the hole 21b1 in the bearing 21b.

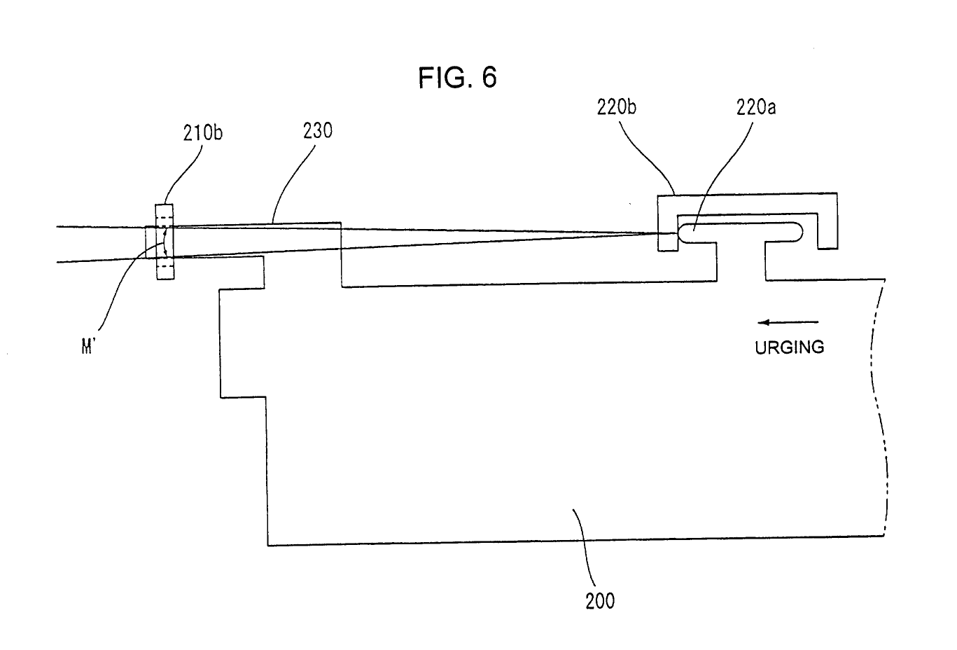

On the contrary, a biasing force may be applied to the door 200 in a direction of the arrow as shown in FIG. 6. The supporting shaft 230 is supported by the bearing 210b, and a positioning projection 220a coaxial with the supporting shaft 230 is contacted with the positioning portion 220b provided on the cabinet side at the upper end of a central part of the door 200. In this constitution, the oscillation is able to occur at a fulcrum of point P′ due to vibration, so that the amount of oscillation M′ is increased to possibly produce the vibration noise. Thus, it is very important that the positioning portion (boss 22 in this embodiment) of the supporting shaft 23 and the bearing 21b are formed proximately. To prevent the vibration noise, it is favorable to have a shorter distance between them. However, since it is required that the occurrence of vibration noise can be actually prevented, the distance can be appropriately adjusted depending on the hardness of the door 20 or the front cabinet 15, the extent of warpage, and the level of vibration produced by the speakers 14.

(4) Second Embodiment

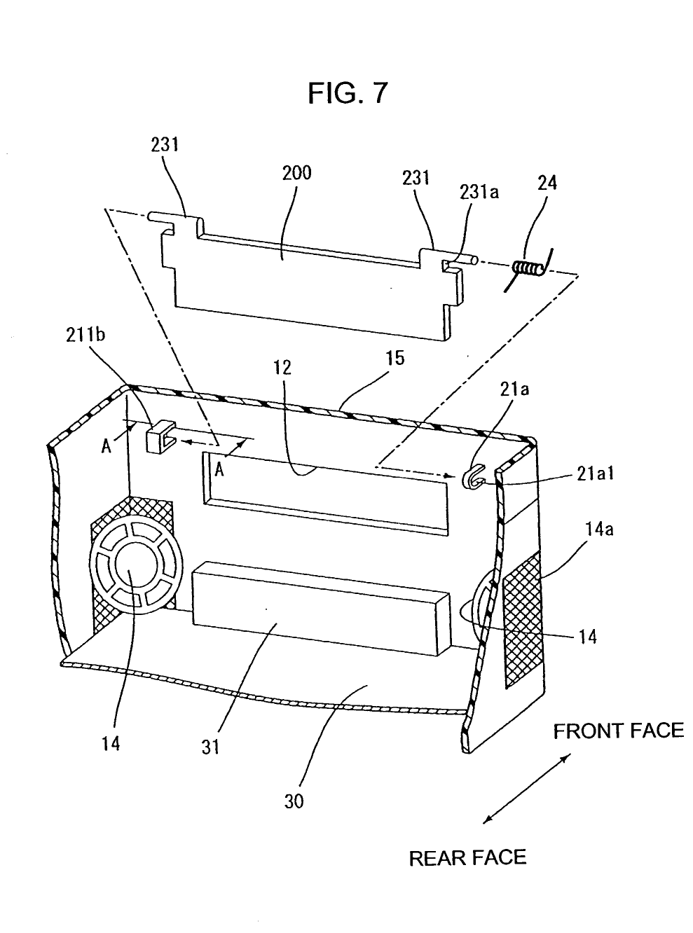

In this invention, the supporting shaft and the positioning portion may be contacted substantially in point contact by making axial alignment at a position proximate to the bearing. The constitution is not limited to those above described, but maybe realized invarious ways. FIG. 7 is an exploded perspective view showing a front cabinet for an integral apparatus of television and video deck according to a second embodiment in which the bearing and the positioning portion are integrated, partly cut away, as seen from the back face. This second embodiment is different from the first embodiment in that a bearing positioning portion 211b is provided instead of the bearing 21b and the boss 22, and the shape of an end face of the supporting shaft is changed. In FIG. 7, the same parts as in the first embodiment are designated by the same numerals of FIG. 2.

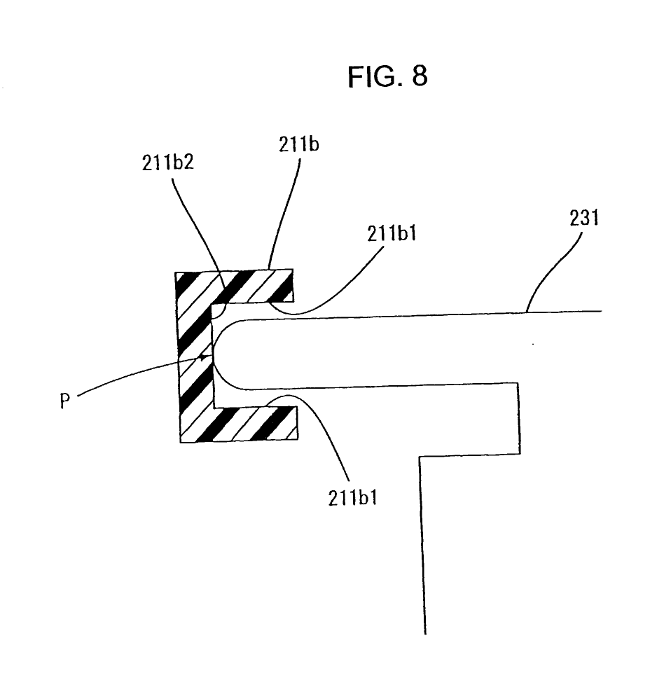

The bearing positioning portion 211b is integrally molded on the back face of the front cabinet 15 to protrude substantially perpendicular to the back face. This bearing positioningv portion 211b has four faces substantially perpendicular to the back face and one face substantially parallel to the back face. One of the four faces on the side of the opening portion 12 is removed, that is, the bearing positioning portion 211b includes two faces 211b1 substantially parallel to each other and a contact face 211b2 substantially perpendicular to the two faces 211b1, defining almost U-character shaped section as shown in FIG. 8. The distance between the two faces 211b1 substantially parallel to each other to form the U-character shape is greater than the outer diameter of the supporting shaft 231.

The end face of the supporting shaft 231 is formed substantially semi-spherically. Accordingly, in supporting the door 20 on the back face of the front cabinet 15, if one end of the supporting shaft 231 is supported through the bearing 21a, and the other end is supported through the bearing positioning portion 211b, the semi-spherical end face of the supporting shaft 231 and the planar contact face 211b2 are contacted substantially at one point P due to a biasing force of the spring 24. Also, it can be mentioned that the two faces 211b1 serve as the bearing of the supporting shaft 231. Therefore, the bearing and the positioning portion are composed of adjacent faces, respectively, and disposed very closely. Accordingly, it is possible to prevent the occurrence of vibration noise very effectively in this embodiment.

(5) Other Embodiment

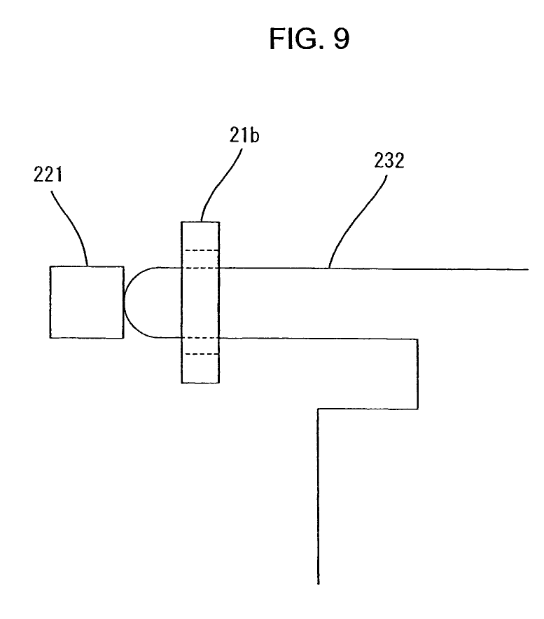

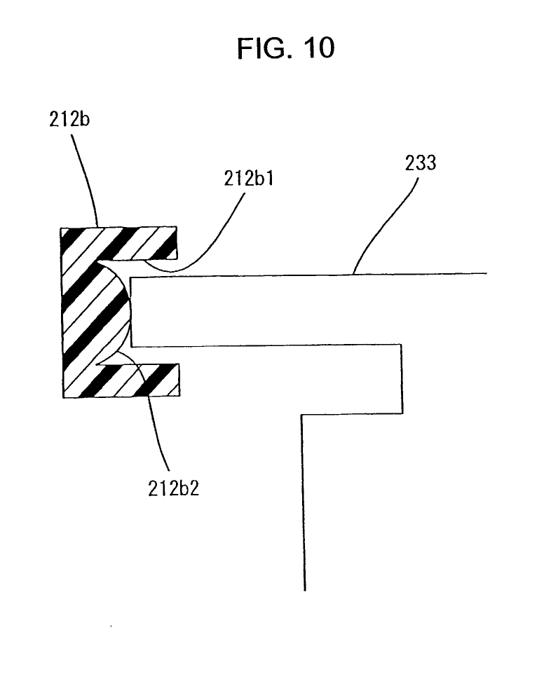

In the above embodiment, the cylindrical boss 22 and the supporting shaft 23 with an planar end face are contacted, or the planar contact face 211b2 and the semi-spherical supporting shaft 231 are contacted and kept in contact substantially at one point. However, these shapes, the combination of plane and curved face, or the bearing configuration are not limited to those mentioned above. FIGS. 9 and 10 are enlarged views of the bearing portion according to another embodiment of the invention.

The embodiment of FIG. 9 is different from the first embodiment in the respects of the shape of boss and the shape of end face of the supporting shaft. In FIG. 9, a boss 221 is formed like a prism, its one face being oriented substantially perpendicular to the axial direction of the supporting shaft. An end face of the supporting shaft 232 is semi-spherical, and other parts are the same as in the first embodiment. In the embodiment as shown in FIG. 9, the boss 221 and the end face of the supporting shaft 232 are contacted substantially in point contact, and the boss 221 as the positioning portion and the bearing 21b are very proximate. Accordingly, it is possible to prevent the occurrence of vibration noise effectively.

The embodiment of FIG. 10 is different from the second embodiment in the respects of the shape of bearing positioning portion and the shape of end face of the supporting shaft. In FIG. 10, a contact face 212b2 of the bearing positioning portion 212b with the supporting shaft 232 is semi-spherical, and an end face of the supporting shaft 233 is planar. Also, two faces 212b1 that are bearings with the end portion of the supporting shaft 233 carried between them are adjacent faces to the contact face 212b2. Accordingly, in the embodiment of FIG. 10, the contact face 212b2 and the end face of the supporting shaft 233 are contacted substantially in point contact, and the contact face 212b2 as the positioning portion and two faces 212b1 as the bearings are very proximate. Accordingly, it is possible to prevent the occurrence of vibration noise effectively.

In this way, in this invention, the door supported rotatably via the supporting shaft has the end face of the supporting shaft urged in the direction of rotation axis by an elastic member to make the end face of the supporting shaft and the positioning portion contact. Herein, both are contacted substantially in point contact. Accordingly, even if the door is subjected to vibration, the contact state between the end face of the supporting shaft and the positioning portion is likely to be maintained. Also, the positioning portion and the supporting shaft are made very proximate. Accordingly, even if the supporting shaft is oscillated, there is no significant movement at the bearing positions. Therefore, it is possible to prevent the occurrence of vibration noise easily and effectively without the use of the lubricant.

What is claimed is:

1. An integral apparatus of television and video deck, comprising:
a cabinet having an opening portion on a front face of the cabinet to allow insertion of a video cassette into the cabinet;
a door having a rotation plane for covering the opening portion;
a supporting shaft provided on the door for rotating the rotation plane, the supporting shaft having a contact face on one end thereof;
a helical spring in which another end of the supporting shaft is inserted;
first and second bearings disposed on an inner surface of the cabinet, each of bearings, in which the supporting shaft is inserted, having a wider clearance than an outer diameter of the supporting shaft; and
a boss disposed in the vicinity of the second bearing,
wherein the helical spring is interposed between a side end portion of the door and the first bearing, each of end portions of the spring is stretched in a tangential direction of the helical circle of the spring, one end portion of the spring is in contact with the cabinet and the other end portion of the spring is in contact with the door to exert a rotation restoring force of the spring on the door to urge the rotation plane toward the opening portion so that the opening portion is closed with the door at a normal state,
the boss is formed substantially cylindrically, the boss protrudes from the inner surface of the cabinet almost orthogonally to a direction along which the supporting shaft is disposed,
the contact face is formed substantially planar,
the door is urged toward the contact face of the supporting shaft by the spring of which one end is in contact with the first bearing, and the contact face is in contact with an outer circumferential curved face of the boss.

2. An integral apparatus of television and video deck, comprising:
a cabinet having an opening portion on a front face of the cabinet to allow insertion of a video cassette into the cabinet;
a door having a rotation plane for covering the opening portion;
first and second supporting shafts provided on the door for rotating the rotation plane, the supporting shafts having a common shaft center and protruding in opposite directions to each other, the second supporting shaft having a contact face on a protruding end thereof;
a helical spring in which the first supporting shaft is inserted;
first and second bearings disposed on an inner surface of the cabinet, each of bearings, in which the first and second supporting shaft is inserted respectively, having a wider clearance than an outer diameter of the supporting shafts; and
a boss disposed in the vicinity of the second bearing,
wherein the helical spring is interposed between a side end portion of the door and the first bearing, each of end portions of the spring is stretched in a tangential direction of the helical circle of the spring, one end portion of the spring is in contact with the cabinet and the other end portion of the spring is in contact with the door to exert a rotation restoring force of the spring on the door to urge the rotation plane toward the opening portion so that the opening portion is closed with the door at a normal state,
the boss is formed substantially cylindrically, the boss protrudes from the inner surface of the cabinet almost orthogonally to a direction along which the first and second supporting shafts are disposed,
the contact face is formed substantially planar,
the door is urged toward the contact face of the second supporting shaft by the spring of which one end is in contact with the first bearing, and the contact face is in contact with an outer circumferential curved face of the boss.

3. A door supporting structure, comprising:
a cabinet having an opening portion;
a door for covering the opening portion;
first and second supporting shafts provided on the door and protruding in opposite directions to each other, the supporting shafts having a common shaft center around which the door is rotated, the second supporting shaft having a contact face on a protruding end;
a pair of bearings disposed on an inner surface of the cabinet, each of the bearings having a shaft inserting portion in which the first and second supporting shaft is inserted respectively;
an elastic member disposed on the first supporting shaft, the elastic member exerting an urging force and a rotation force on the door; and
a positioning portion disposed in the vicinity of the contact face,
wherein the elastic member is interposed between the door and one of the bearings to urge the door along the shaft center so that the contact face passed through the other bearing is in contact with the positioning portion disposed in the vicinity of the other bearing.

4. A door supporting structure, comprising:
a cabinet having an opening portion to allow insertion of an inserting object;
a door having a rotation plane for covering the opening portion;
first and second supporting shafts provided on the door for rotating the rotation plane, the second supporting shaft having a contact face on protruding end thereof;
at least two bearings disposed on the cabinet, each of the bearings having a shaft inserting portion in which each of the first end second supporting shafts is inserted;,
an elastic member disposed on the first supporting shaft, the elastic member exerting an urging force on the door in a direction of the supporting shaft, the elastic member exerting a rotation restoring force on the door in a direction around the urging force; and
a positioning portion disposed in the vicinity of one of the bearings,
wherein the contact face of the second supporting shaft is in contact with the positioning portion by the urging force of the elastic member to determine an axial position of the door, the positioning portion is contactable with the contact face substantially in point contact.

5. The door supporting structure according to claim 3, wherein one of the contact face and a contact region of the positioning portion is almost planar, and the other is almost curved.

6. The door supporting structure according to claim 3, wherein the positioning portion is a substantially cylindrical boss that is protruded almost orthogonally to a direction along which the supporting shaft is disposed.

7. The door supporting structure according to claim 3, wherein the positioning portion is a member connected with one of the bearings to define a U-shaped cross section with the bearing, the contact face of the supporting shaft is curved.
